(19) United States
(12) Patent Application Publication
(10) Pub. No.: US 2018/0313625 A1
(43) Pub. Date: Nov. 1, 2018

(54) APPARATUS AND METHOD FOR CONNECTING COMPONENTS OF A FIREARM SUPPRESSOR

(71) Applicant: Nicholas Tomczak, Richlands, NC (US)

(72) Inventor: Nicholas Tomczak, Richlands, NC (US)

(21) Appl. No.: 15/963,456

(22) Filed: Apr. 26, 2018

Related U.S. Application Data
(60) Provisional application No. 62/490,259, filed on Apr. 26, 2017.

(51) Int. Cl. F41A 21/30; B23K 31/02; B23K 31/00

(52) U.S. Cl. CPC F41A 21/30; B23K 2201/04; B23K 31/003; B23K 31/027

(57) ABSTRACT

The present invention describes a stronger and more durable welded joint for attaching individual baffle members and spacer members within a firearm suppressor or silencer. In the preferred embodiment, the diameter of the individual spacers is slightly larger than the diameter of the adjacent baffle members at the joint. Additionally, the thickness of the spacer member casing increases as it approaches the joint. When the spacer members are attached to the ends of the baffle members, this configuration produces a joint such that the entire well seam is inside the diameter of the adjacent spacers, i.e. no material extends beyond the diameter of the spacer. The extra material on the spacer at the baffle/spacer joint is then melted along with the baffle material to form a stronger welded joint that does not extend beyond the diameter of the spacer.

### RELATED APPLICATIONS

This application claims priority to U.S. Provisional Application No. 62/490,259 filed Apr. 26, 2017. The entire contents of the above application are hereby incorporated by reference as though fully set forth herein.

### BACKGROUND

This invention relates to suppressors or silencers for firearms. More particularly, this invention relates to an apparatus and method for connecting individual baffle members and spacer members within a suppressor or silencer.

To fire a bullet from a firearm, gunpowder is ignited behind a bullet. The gunpowder creates a high-pressure pulse of hot gas. The pressure of the gas forces the bullet down the barrel of the gun. When the bullet exits the end of the firearm barrel, the pressure behind the bullet is immense and just like popping the cork on a bottle; the “pop” sound it creates is very loud. The sound is from the initial pressure wave coming out the barrel. Additional gas comes out after the initial pressure wave but not as much as the initial wave.

Known suppressors or silencers typically consist of an outer housing that is connectable to the end of the rifle barrel by screw threads. Traditional suppressors or silencers have a larger volume compared to the barrel (20 or 30 times greater). With the suppressor or silencer in place, the pressurized gas behind the bullet has a big space to expand into, decreasing the pressure of the heated gas. When the bullet finally exits through the hole in the suppressor or silencer, the pressure being released is decreased; therefore, the sound of the gun firing is much softer.

The interior of the housing of typical suppressors or silencers support a plurality of individual cone-shaped baffle members separated by spacer members. There is a balancing act with suppressors or silencers used with many firearms. The baffles within the suppressors are needed to divert the gas from the bore in order to allow the gas to expand and depressurize; but, if the suppressor or silencer is too efficient in slowing gas down, it builds up an excess amount of pressure in the firearm barrel and causes the firearm to malfunction.

In a traditional suppressor or silencer, the baffles are welded into position between a series of spacers using filler rod. During a fusion welding process, some of the filler rod material ends up being elevated above the original diameter of the baffle and spacers and the excess filler rod material must be milled or lathed away prior to putting the outer tubular casing over the baffle and spacers. When part of the weld is removed, it makes the joint weaker.

There is a point of diminishing returns on efforts to eliminate sound from a firearm since a suppressor cannot eliminate the supersonic shockwave, or “crack” caused by the bullet traveling in excess of the speed of sound. Instead, it is important to focus on inventive concepts that allow the suppressor or silencer to be made smaller, cheaper, stronger, more durable and/or lighter in weight.

As such, there would be an advantage of having a more efficient way to weld the baffles into position between spacers that does not require the use of filler rod and then subsequent milling or lathing to remove excess material.

### BRIEF SUMMARY OF THE INVENTION

The present invention seeks to meet these needs by providing a stronger, more durable, and potentially shorter and lighter suppressor by using a baffle/spacer joint wherein the diameter of the individual spacers is slightly larger than the diameter of the adjacent baffle members. Additionally, the thickness of the spacer member casing increases as it approaches the joint. This configuration produces a joint such that the entire well seam is inside the diameter of the spacer, i.e. no material extends beyond the diameter of the spacer. The extra material on the spacer at the baffle/spacer joint is used for the filler material in the welding process, thus eliminating the need for a filler rod and subsequent milling or lathing of excess material, resulting in a stronger welded joint.

### BRIEF DESCRIPTION OF THE DRAWINGS

FIG. 1 is a cross sectional view of a traditional suppressor or silencer for a firearm.

FIG. 2 is a cross sectional side view of the baffle/spacer joints of the subject invention depicting the weld seam before being welded.

FIG. 3 is a close up cross sectional view of the baffle and spacer joint of the present invention showing the joint before and after welding.

FIG. 4 is an exploded view of the suppressor or silencer for a firearm that breaks down the configuration of the baffles in relation to the spacers within the outer casing.

### DETAILED DESCRIPTION

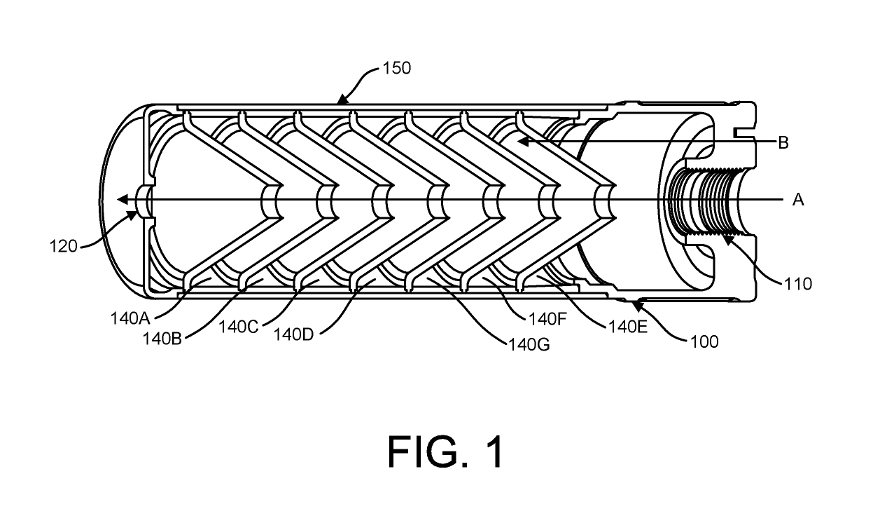

Turning to FIG. 1, a traditional suppressor or silencer for a firearm is shown in cross sectional detail. The tubular casing 100 is threaded at 110 onto the end of the firearm (not shown). The bullet travels along the path of A, exiting the hole 120. The gas travels along path A and exits out of hole 120. The gas also travels along path B and expands into the chambers created by a series of flat angled baffles, shown as 140A-G.

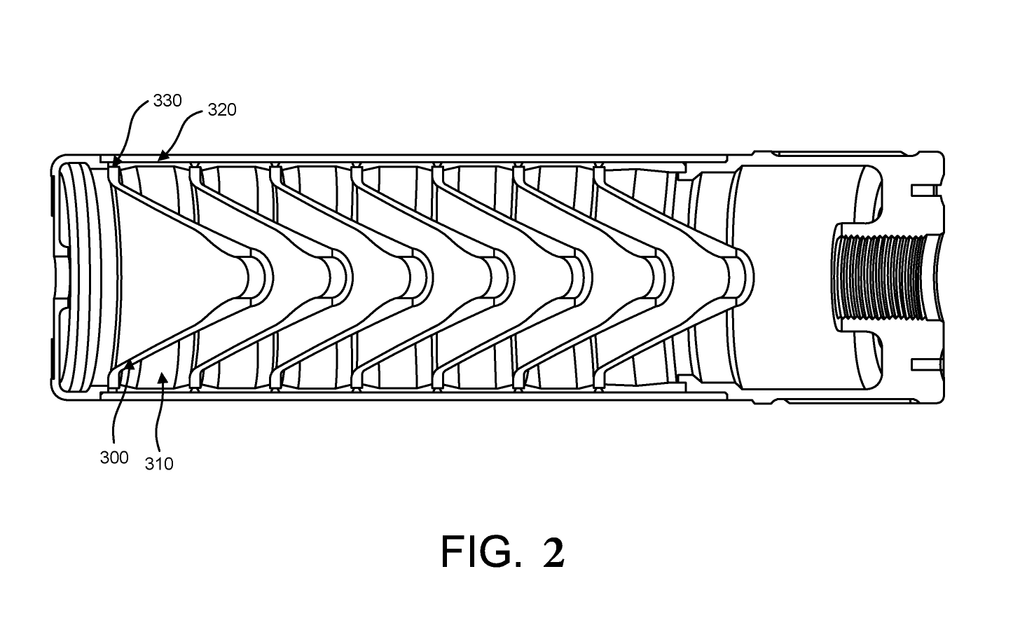

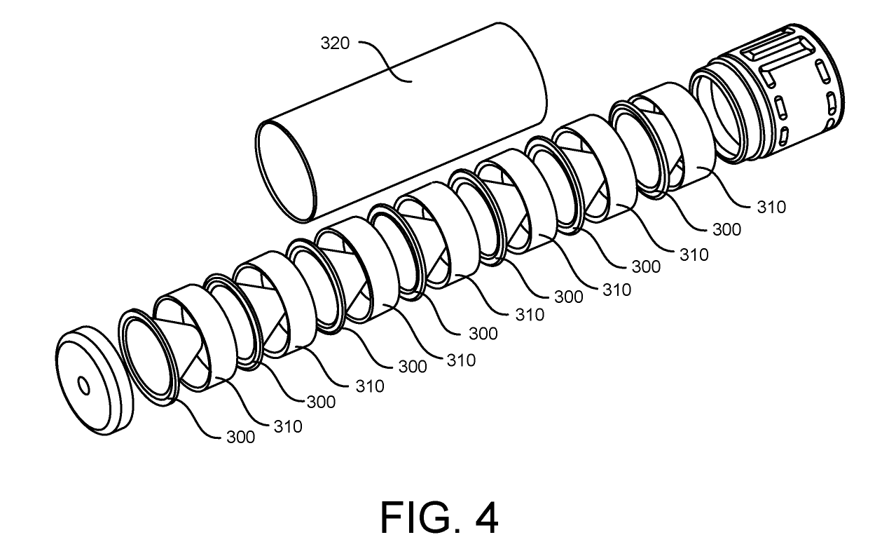

Turning to FIG. 2, the baffle and spacer joint 330 of the present invention is constructed from a baffle 300 that is a hollow tubular body of cylindrical cross section casing narrowing to a cone shape having sides that define an inlet and outlet end with an interior and exterior surface and a spacer 310 that is a hollow tubular body of cylindrical cross section that defines an inlet and outlet end with an interior and exterior surface. A tubular casing 320 surrounds the joint 330 created by the baffle 300 and spacer 310. An exploded view of the configuration of baffle and spacer elements within the suppressor can be seen in FIG. 4.

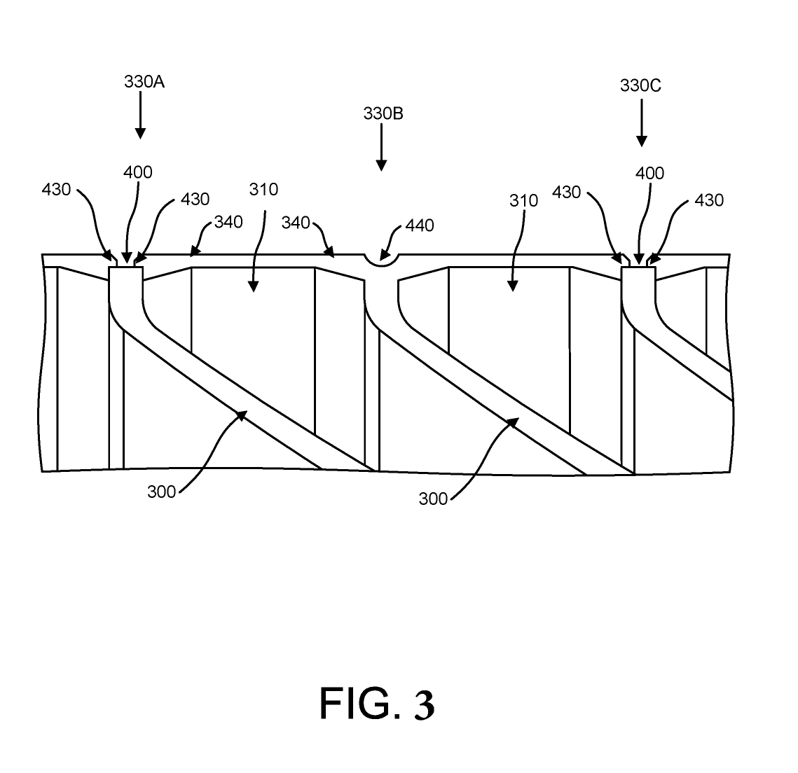

Turning to FIG. 3, the thickness 340 of the spacer 310 casing increases as it approaches the baffle/spacer joints 330A-C allowing for excess heat to be applied at the joint during welding. The joints 330A and 330C are prior to welding and joint 330B is after welding. Prior to welding, a Y-shaped portion 400 between the baffle 300 and spacer 310 is empty at the joint such that the entire well seam is inside the diameter of the spacer 310, i.e. no material extends beyond the outer diameter of the spacer 310. When welded, the edges 430 of the spacer 310 itself becomes sacrificial material and no filler rod is added in the welding process. The result is a stronger joint without the need for subsequent milling or lathing of excess material in order to have a smooth finish that will fit within the suppressor casing. Additionally, the mechanics of the fusion weld leave a void space 440 at the joint between the joint and the outer diameter of the spacer, resulting in an overall lighter connection.

For the purposes of promoting an understanding of the principles of the invention, reference has been made to the preferred embodiments illustrated in the drawings, and specific language has been used to describe these embodiments. However, this specific language intends no limitation of the scope of the invention, and the invention should be construed to encompass all embodiments that would normally occur to one of ordinary skill in the art. The particular implementations shown and described herein are illustrative examples of the invention and are not intended to otherwise limit the scope of the invention in any way. For the sake of brevity, conventional aspects of the system (and components of the individual operating components of the system) may not be described in detail. Furthermore, the connecting lines, or connectors shown in the various figures presented are intended to represent exemplary functional relationships and/or physical or logical couplings between the various elements. It should be noted that many alternative or additional functional relationships, physical connections or logical connections may be present in a practical device. Moreover, no item or component is essential to the practice of the invention unless the element is specifically described as “essential” or “critical”. Numerous modifications and adaptations will be readily apparent to those skilled in this art without departing from the spirit and scope of the present invention.

What is claimed is:

1. A suppressor for a firearm comprising:
a. a tubular housing of cylindrical cross section having an interior cavity comprising a front end and a back end;
b. a plurality of baffles with a hollow tubular body of cylindrical cross section having sides that define a gas inlet and a gas outlet end, an interior and exterior surface, and are nested within each other in the interior cavity of the tubular housing;
c. a plurality of spacers between each baffle in the interior cavity of the tubular housing having a hollow tubular body of cylindrical cross section that define an inlet and outlet end with an interior and exterior surface wherein the tubular body increases in thickness towards its ends resulting in the spacers having a greater outer diameter than the gas outlet ends of the baffles;
wherein the end of each spacer is attached to the gas outlet end of the adjacent baffle to form a joint.

2. The suppressor of claim 1 wherein the joint is formed by heating the excess material of the spacer ends and the baffle material forming the base of the joint to their melting point to allow the two materials to mix and bond together.

3. The suppressor of claim 1 wherein the joint does not exceed the outer diameter of the spacer.

4. A suppressor for a firearm comprising:
a. a tubular housing of cylindrical cross section having an interior cavity comprising a front end and a back end;
b. a plurality of baffles with a hollow tubular body of cylindrical cross section having sides that define a gas inlet and a gas outlet end, an interior and exterior surface, and are nested within each other in the interior cavity of the tubular housing;
c. a plurality of spacers between each baffle in the interior cavity of the tubular housing having a hollow tubular body of cylindrical cross section that define an inlet and outlet end with an interior and exterior surface wherein the tubular body increases in thickness towards its ends resulting in the spacers having a greater outer diameter than the gas outlet ends of the baffles;
wherein the joining of the ends of the spacers and the gas outlet ends of the baffles creates an empty cavity with the thicker ends of the spacers forming the sides and the gas outlet ends of the baffle forming the base, and the additional side material of the spacer is used to fuse the spacers and baffles together to form a joint.

5. The suppressor of claim 4 wherein the joint is formed by heating the excess material of the spacer ends and the baffle material forming the base of the joint to their melting point to allow the two materials to mix and bond together.

6. The suppressor of claim 4 wherein the thickness of the joint does not exceed the outer diameter of the spacer.

7. A suppressor for a firearm comprising:
a. a tubular housing of cylindrical cross section having an interior cavity comprising a front end and a back end;
b. a plurality of baffles with a hollow tubular body of cylindrical cross section having sides that define a gas inlet and a gas outlet end, an interior and exterior surface, and are nested within each other in the interior cavity of the tubular housing;
c. a plurality of spacers between each baffle in the interior cavity of the tubular housing having a hollow tubular body of cylindrical cross section that define an inlet and outlet end with an interior and exterior surface wherein the tubular body increases in thickness towards its ends resulting in the spacers having a greater outer diameter than the gas outlet ends of the baffles;
wherein the ends of the spacers and the gas outlet ends of the baffles form a joint that does not extend beyond the outer diameter of the spacer.

8. A method for welding a baffle to a spacer in a suppressor for a firearm comprising:
a. creating a baffle that is a hollow tubular body of cylindrical cross section having sides that define a gas inlet and a gas outlet end;
b. creating a spacer that is a hollow tubular body of cylindrical cross section that define an inlet and outlet end with an interior and exterior surface wherein the tubular body increases in thickness towards its ends resulting in the spacers having a greater outer diameter than the gas outlet ends of the baffles;
c. aligning the spacer and baffle such that the outer diameter of the spacer is slightly higher than the outer diameter of the gas outlet end of the baffle, which creates excess material on the spacer end above the gas outlet end of the baffle;
d. heating the excess material of the spacer end and the adjacent baffle end to their melting point to allow the two materials to mix and bond together; and
e. allowing the bonded material to cool in order to make a strong joint.
